(19) United States
(12) Patent Application Publication
(10) Pub. No.: US 2026/0106858 A1
(43) Pub. Date: Apr. 16, 2026

(54) ENHANCED USER PRIVACY AND POWER SAVING FOR DEVICE ADDRESS ROTATION

(71) Applicant: Google LLC, Mountain View, CA (US)

(72) Inventors: Russell William Myers, Marietta, GA (US); Calvin On, Mountain View, CA (US); Sumukh Ashok Shevde, Encinitas, CA (US)

(21) Appl. No.: 18/912,057

(22) Filed: Oct. 10, 2024

(51) Int. Cl. H04L 61/5053; H04L 101/622; H04W 52/02

(52) U.S. Cl. CPC H04L 61/5053; H04W 52/0235; H04L 2101/622

(57) ABSTRACT

Techniques are described for triggering, by an address rotation unit of a computing device, determination of a first address identifier for the computing device, wherein the first address identifier is an active address identifier for the computing device that identifies the computing device according to a wireless communication protocol, and wherein the address rotation unit is a distinct component from a processing unit of the computing device; in response to the address rotation unit determining a timer elapses, triggering, by the address rotation unit and while the processing unit is operating in a low-power mode, determination of a second address identifier for the computing device; setting, by the computing device, the second address identifier as the active address identifier for the computing device; and broadcasting, by the computing device and based on the active address identifier, an advertisement, wherein the advertisement conforms to the wireless communication protocol.

### BACKGROUND

A computing device may communicate with one or more remote devices via a wireless communication protocol. The remote devices may identify, wirelessly connect to, or otherwise communicate with the computing device based on an address identifier associated with the computing device.

### SUMMARY

In general, aspects of the techniques of this disclosure are directed to performing device address rotation while a processing unit (e.g., a central processing unit) of the device is operating in low power mode. A computing device may perform address rotation to improve privacy associated with the computing device searching for remote devices via a wireless communication protocol (e.g., a local area network protocol, a personal area network protocol, etc.). For example, the computing device may search for remote devices using a first address identifier. After a period of time has elapsed, the computing device may replace the first address identifier with a second address identifier to use as the active address identifier when searching for remote devices, thereby improving privacy of the computing device by periodically replacing or rotating address identifiers associated with the computing device. The computing device, in accordance with the techniques described herein, may include a dedicated address rotation unit that requires less power to operate than an application processor, central processing unit, or other similar processors and is configured to manage a timer for triggering address rotation for the computing device. In this way, the computing device may perform address rotation for the computing device while a processing unit of the computing device is in low power mode.

In some aspects, the techniques described herein relate to a method including triggering, by an address rotation unit of a computing device, determination of a first address identifier for the computing device, wherein the first address identifier is an active address identifier for the computing device that identifies the computing device according to a wireless communication protocol, and wherein the address rotation unit is a distinct component from a processing unit of the computing device. The method may further include in response to the address rotation unit determining a timer elapses, triggering, by the address rotation unit and while the processing unit is operating in a low-power mode, determination of a second address identifier for the computing device. The method may further include setting, by the computing device, the second address identifier as the active address identifier for the computing device. The method may further include broadcasting, by the computing device and based on the active address identifier, an advertisement, wherein the advertisement conforms to the wireless communication protocol.

In some aspects, the techniques described herein relate to a computing device including a processing unit, a wireless communication device, an address rotation unit, and a storage device. The storage device may store instructions executable by the address rotation unit to trigger determination of a first address identifier for the computing device, wherein the first address identifier is an active address identifier for the computing device that identifies the computing device according to a wireless communication protocol, and wherein the address rotation unit is a distinct component from the processing unit. The storage device may further store instructions executable by the address rotation unit to determine a timer elapses. The storage device may further store instructions executable by the address rotation unit to trigger, based on the timer and while the processing unit is operating in low-power mode, determination of a second address identifier for the computing device. The storage device may store instructions executable by the wireless communication device to set the second address identifier as the active address identifier for the computing device. The storage device may further store instructions executable by the wireless communication device to broadcast, based on the active address identifier, an advertisement, wherein the advertisement conforms to the wireless communication protocol.

In some aspects, the techniques described herein relate to non-transitory computer-readable storage media storing instructions that, when executed, cause a computing device to: trigger, by an address rotation unit of the computing device, determination of a first address identifier for the computing device, wherein the first address identifier is an active address identifier for the computing device that identifies the computing device according to a wireless communication protocol, and wherein the address rotation unit is a distinct component from a processing unit of the computing device. The instructions may further cause the computing device to, in response to the address rotation unit determining a timer elapses, trigger, by the address rotation unit and while the processing unit is operating in low-power mode, determination of a second address identifier for the computing device. The instructions may further cause the computing device to set the second address identifier as the active address identifier for the computing device. The instructions may further cause the computing device to broadcast, based on the active address identifier, an advertisement, wherein the advertisement conforms to the wireless communication protocol.

In some aspects, the techniques described herein relate to a computer program product comprising one or more instructions that, when executed by an address rotation unit of a computing device, cause the address rotation unit to trigger determination of a first address identifier for the computing device, wherein the first address identifier is an active address identifier for the computing device that identifies the computing device according to a wireless communication protocol, and wherein the address rotation unit is a distinct component from a processing unit of the computing device. The one or more instructions may further cause the address rotation unit to determine a timer elapses. The one or more instructions may further cause the address rotation unit to trigger, based on the timer and while the processing unit is operating in low-power mode, determination of a second address identifier for the computing device.

The details of one or more examples of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a conceptual diagram illustrating an example computing environment for triggering address rotation for an example computing device using an example address rotation unit, in accordance with one or more aspects of the present disclosure.

FIG. 2 is a conceptual diagram illustrating an example computing device with an example address rotation unit configured to trigger address rotation for the example computing device, in accordance with one or more aspects of the present disclosure.

FIG. 3 is a flowchart of an example process for triggering address rotation while a processing unit is operating in a low-power mode, in accordance with one or more aspects of the present disclosure.

### DETAILED DESCRIPTION

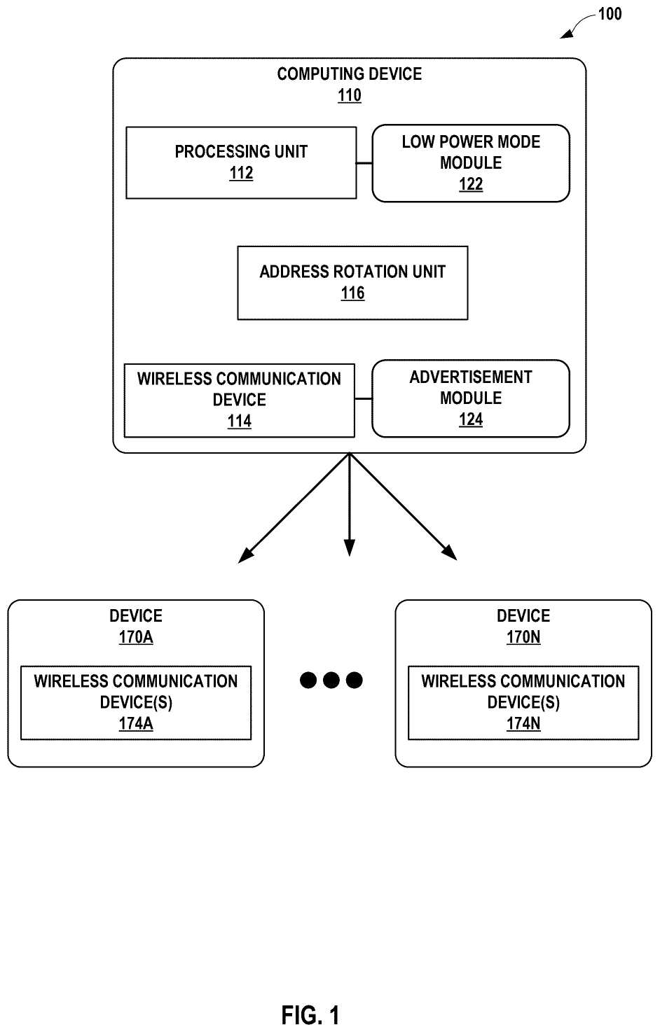

FIG. 1 is a conceptual diagram illustrating example computing environment 100 for triggering address rotation for example computing device 110 based on a timer implemented by example address rotation unit 116, in accordance with one or more aspects of the present disclosure. Computing environment 100 may include computing device 110 and devices 170A-170N (collectively referred to herein as “devices 170”). Devices 170 may include mobile computing devices, such as mobile phones (including smartphones), laptop computers, tablet computers, wearable computing devices, vehicle displays, smart televisions, smart home devices, virtual or augmented reality devices, smart glasses, internet of things (IoT) devices, spatial computing devices, or any other computing device that may connect to other devices via a wireless communication protocol. Devices 170 may include respective one or more wireless communication devices 174A-174N (collectively referred to herein as “wireless communication devices 174”). Wireless communication devices 174 may communicate with one or more external devices via one or more wireless communication protocols by transmitting and/or receiving network signals according to the one or more wireless communication protocols. Wireless communication devices 174 may include a personal area network chip, a network interface card, an optical transceiver, a radio frequency transceiver, a GNSS receiver, or any other type of device that can send and/or receive information. Other examples of wireless communication devices 174 may include short wave radios, cellular data radios (for terrestrial and/or satellite cellular networks), wireless network radios, as well as universal serial bus (USB) controllers.

Computing device 110 may represent a computing device, such as a mobile phone (including a smartphone), a laptop computer, a tablet computer, a wearable computing device, a vehicle display, a smart television, smart home devices, a virtual or augmented reality device, smart glasses, an internet of things (IoT) device, a spatial computing device, or any other computing device that may connect to other computing devices via a wireless communication protocol. Computing device 110 may include processing unit 112, low power mode module 122, wireless communication device 114, advertisement module 124, and address rotation unit 116. Wireless communication device 114 may communicate with one or more external devices (e.g., devices 170) via one or more wireless communication protocols by transmitting and/or receiving network signals according to the one or more wireless communication protocols. Wireless communication device 114 may represent a personal area network chip, a network interface card, an optical transceiver, a radio frequency transceiver, a GNSS receiver, short wave radios, cellular data radios (for terrestrial and/or satellite cellular networks), wireless network radios, universal serial bus (USB) controllers, or any other type of device that can send and/or receive information.

In the example of FIG. 1, computing device 110, or more specifically wireless communication device 114, may wirelessly communicate with devices 170 that are in a communication range associated with one or more wireless communication protocols. Wireless communication protocols may include protocols enabling communication between computing devices, network devices, computing systems, etc., such as protocols for personal area networks (e.g., Bluetooth™ Low Energy (BLE) or any variations thereof, Wi-Fi™ Direct, Wi-Fi™ Aware, Near Field Communication, etc.) or protocols for local area networks (e.g., Wi-Fi™ 6 or any variations thereof, Zigbee™, MQTT™, long range wireless area network (WAN) protocols, low-power radio frequency communication protocols, etc.). Wireless communication device 114 may broadcast advertisements (e.g., personal area network advertisements, local area network advertisements, etc.) to devices 170 to establish connections or exchange information. Wireless communication device 114 may broadcast advertisements such as connection requests, service availability, general announcements, device names, transmission power level, a list of supported services, or the like. Wireless communication device 114 may broadcast advertisements according to an advertising interval (e.g., on the range of milliseconds to seconds). Wireless communication device 114 may implement advertisement module 124 to generate advertisements to broadcast to devices 170, for example.

Advertisement module 124 may include computer readable instructions for generating advertisements according to one or more wireless communication protocols. For example, advertisement module 124 may be configured to generate personal area network advertisements according to a personal area network protocol (e.g., BLUETOOTH protocol) and/or local area network advertisements according to a local area network protocol (e.g., WI-FI protocol). Advertisement module 124 may generate advertisements as data payloads and/or scan response payloads that include active address identifiers (e.g., private addresses that conceal an identity address) for computing device 110 that advertisement module 124 may generate responsive to instructions received by address rotation unit 116.

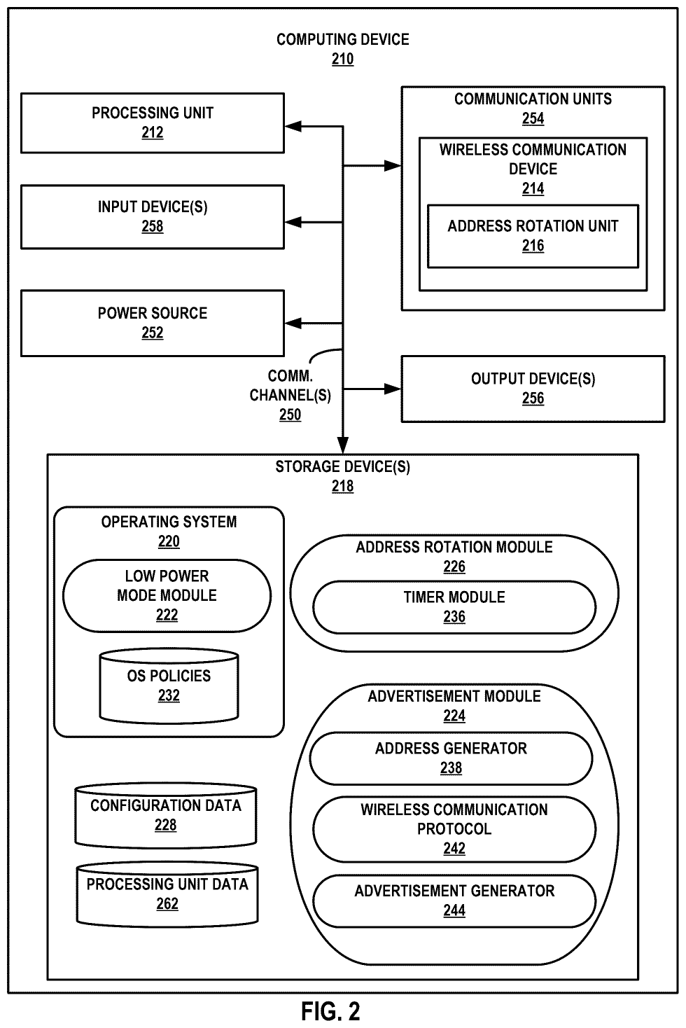

Address rotation unit 116 may include a system on a chip (SOC), a microcontroller unit (MCU), or other always-on-cores (AOC). Address rotation unit 116 may be configured to perform connection management tasks, such as enforcing an address rotation timer for triggering address rotation, in a way that is isolated from core processing unit stacks, such as processing unit 112. Although illustrated as external to wireless communication device 114, in some examples, as seen in FIG. 2, address rotation unit 116 may be a component of wireless communication device 114.

Processing unit 112 may implement functionality and/or execute instructions within computing device 110. For example, processing unit 112 may receive and execute instructions that provide the functionality of components (e.g., software applications, user interface modules, display devices, etc.) of computing device 110. Processing unit 112 may represent one or more central processing units (CPUs), graphical processing units (GPUs), tensor processing units (TPUs), or any other processing unit of computing device 110 that implements core functionality within computing device 110. For example, processing unit 112 may represent a CPU that manages, processes data for, and generates instructions for software and hardware components of computing device 110.

Low power mode module 122 may instruct processing unit 112 to operate in a low-power mode. Low power mode module 122 may include computer readable instructions for causing processing unit 112 to enter various types of low-power modes, such as an idle mode, a sleep mode, a deep sleep mode, a standby mode, a hibernate mode, doze mode, retention mode, ultra-low power mode, adaptive power modes, or the like. Low power mode module 122 may instruct processing unit 112 to enter a low-power mode to reduce power consumption of a power source (e.g., battery) that may be included in computing device 110. In some instances, low power mode module 122 may instruct processing unit 112 to enter low-power mode responsive to a user operating computing device 110 selecting an option to initiate low-power mode (e.g., via a graphical user interface output by computing device 110). In another example, low power mode module 122 may instruct processing unit 112 to enter low-power mode based on operating system policies, such as a current power source capacity of computing device 110. For instance, processing unit 112 may enter low-power mode responsive to low power mode module 122 determining a current power source capacity of computing device 110 is below a threshold (e.g., below 20%).

In general, processing unit 112 may enter low-power mode at any time during operation of computing device 110. Some computing devices may be configured to have processing units, such as processing unit 112, implement address rotation timers for address rotation. Such computing devices that use processing units to manage and enforce address rotation timers may result in the processing units consistently exiting low-power mode in periodic intervals associated with an address rotation timer. Such computing devices may consume additional power (e.g., around 0.1 mWh for wearable computing devices) from a limited power source each time processing units exit low-power mode to trigger address rotation. For example, in instances where a computing device uses a processing unit (e.g., processing unit 112) to trigger address rotation every 10 minutes based on a 10-minute address rotation timer and the processing unit is operating in low-power mode (e.g., based on operating system policies, user selection, etc.), the processing unit may consume power (e.g., 0.1 mWh) every 10 minutes to temporarily wake up to trigger address rotation. For this reason, such computing devices that use processing units (e.g., processing unit 112) to trigger address rotation generally implement timers with a range of time in minutes or hours. Such computing devices may implement address rotation timers as fixed timeout values (e.g., every 10 minutes) to alleviate power consumption associated with potential processing unit wake ups to perform address rotation; however, such computing devices triggering address rotation according to fixed timeout values may compromise user privacy based on a predictability associated with triggering address rotation according to fixed timeout values. If such computing devices use processing units that implement address rotation timers with random intervals (e.g., to avoid compromising user privacy), such computing devices may be prone to consuming additional power associated with randomly waking up processing units to trigger address rotation.

In accordance with the techniques described herein, address rotation unit 116 of computing device 110 may trigger address rotation for computing device 110 while processing unit 112 is in low-power mode. Address rotation unit 116 may trigger address rotation by, for example, sending wireless communication device 114 instructions to set a new address identifier as an active address identifier for computing device 110 responsive to address rotation unit 116 determining an address rotation timer has elapsed or expired. Address rotation unit 116 may enforce an address rotation timer that may define a probability distribution on a time interval (e.g., a uniformly distributed random interval). Address rotation unit 116 may, responsive to the timer elapsing, send instructions to wireless communication device 114 to determine new active address identifiers that identify computing device 110 according to a wireless communication protocol. Address rotation unit 116 may continue to send wireless communication device 114 instructions to determine new active address identifiers based on the timer, even in instances when processing unit 112 is operating in low-power mode. In this way, address rotation unit 116 may implement address rotation timers defining uniformly random intervals with a range of time in seconds to enhance user privacy associated with computing device 110 broadcasting advertisements to devices 170. In addition, address rotation unit 116 is a distinct component from processing unit 112 with independent logic for managing address rotation timers that trigger address rotation for computing device 110; thus, saving power of a power source that computing device 110 may have by allowing processing unit 112 to remain in low-power mode each time an address rotation timer elapses.

In operation, address rotation unit 116 may instruct wireless communication device 114 to determine a first address identifier for computing device 110 while processing unit 112 is operating in a low-power mode initiated using low power mode module 122. Address rotation unit 116 may instruct wireless communication device 114 to determine a first address identifier as an active address identifier that identifies computing device 110 according to a wireless communication protocol associated with wireless communication device 114. For example, address rotation unit 116 may instruct wireless communication device 114 to determine a first address identifier as a first resolvable private address (RPA) that identifies computing device 110 according to a personal area network protocol (e.g., BLE). A resolvable private address for a personal area network, such as BLUETOOTH, may include a combination of an identity or a physical address, such as a media access control (MAC) address, and a private resolvable address generated using a randomly or pseudo-randomly generate key, such as a BLUETOOTH identity resolving key (IRK). Address rotation unit 116 may instruct wireless communication device 114 to determine the first address identifier as a first RPA using a random key to rotate an active address identifier. For example, in instances where the wireless communication protocol is a BLE protocol, address rotation unit 116 instruct wireless communication device 114 to determine a first RPA using a BLUETOOTH IRK that associates the first RPA to an identity address (e.g., MAC address) of computing device 110 that may remain constant. Advertisement module 124 of wireless communication device 114 may store the first address identifier as an active address identifier for computing device 110.

Advertisement module 124 may generate a first advertisement that conforms to the wireless communication protocol associated with wireless communication device 114. Advertisement module 124 may generate the first advertisement based on the first address identifier being the active address identifier. For instance, advertisement module 124 may generate the first advertisement as a personal area network advertisement (e.g., BLUETOOTH advertisement) that includes the first address identifier in a portion of the first advertisement associated with a physical address of computing device 110. Advertisement module 124 may broadcast the first advertisement to devices 170 using wireless communication device 114. Devices 170 may receive the first advertisement using respective wireless communication devices 174. A device of devices 170 (e.g., device 170A) may connect to computing device 110 based on the first advertisement. For instance, one or more wireless communication devices 174 of device 170A may connect to wireless communication device 114 of computing device 110 based on the first advertisement including a connection request with computing device 110. Device 170A may determine the connection request of the first advertisement originated from computing device 110 by, for example, resolving, decrypting, or otherwise interpreting the first address identifier included in the first advertisement. For instance, device 170A may process the connection request of the first advertisement to connect to computing device 110 by resolving the active address identifier of the first RPA using the IRK associated with the first RPA.

Address rotation unit 116 may instruct wireless communication device 114 to determine a second address identifier for computing device 110 while processing unit 112 is operating in the low-power mode. Address rotation unit 116 may instruct wireless communication device 114 to determine the second address identifier as the active address identifier based on a timer. For instance, address rotation unit 116 may be configured with a timer that defines a uniformly distributed random amount of time within a time range of seconds. In response to address rotation unit 116 determining the timer has elapsed, address rotation unit 116 may instruct wireless communication device 114 to determine the second address identifier as the active address identifier that identifies computing device 110 according to the wireless communication protocol associated with wireless communication device 114. For example, address rotation unit 116 may instruct wireless communication device 114 to determine a second address identifier as a second RPA for computing device 110 according to the personal area network protocol (e.g., BLE). Address rotation unit 116 may instruct wireless communication device 114 to determine the second address identifier as a second RPA using an IRK (e.g., the same IRK used to generate the first RPA) that associates the second RPA to the identity address of computing device 110 that may remain constant. Advertisement module 124 may store, in lieu of the first address identifier, the second address identifier as the active address identifier for computing device 110. In other words, advertisement module 124 may set the second address identifier as the active address identifier that identifies computing device 110 to enhance user privacy associated with broadcasted advertisements generated by advertisement module 124.

Advertisement module 124 may generate a second advertisement that conforms to the wireless communication protocol associated with wireless communication device 114. Advertisement module 124 may generate the second advertisement based on the second address identifier being set as the active address identifier. For instance, advertisement module 124 may generate the second advertisement as a personal area network advertisement (e.g., BLUETOOTH advertisement) that includes the second address identifier in a portion of the second advertisement associated with a physical address of computing device 110. Advertisement module 124 may broadcast the second advertisement to devices 170 using wireless communication device 114. Devices 170 may receive the second advertisement using respective wireless communication devices 174. A device of devices 170 (e.g., device 170N) may connect to computing device 110 based on the second advertisement. For instance, one or more wireless communication devices 174N of device 170N may connect to wireless communication device 114 of computing device 110 based on the second advertisement including a connection request with computing device 110. Device 170N may determine the connection request of the second advertisement originated from computing device 110 by, for example, resolving, decrypting, or otherwise interpreting the second address identifier included in the second advertisement. For instance, device 170N may process the connection request of the second advertisement to connect to computing device 110 by resolving the second address identifier of a second RPA using the IRK associated with the second RPA.

In some instances, device 170A may connect to computing device 110 based on the first advertisement. In response to device 170A receiving the second advertisement, device 170 may resolve, decrypt, or otherwise interpret the second address identifier of the second advertisement to determine that the second advertisement originated from computing device 110. Device 170A may reestablish wireless connectivity with computing device 110 based on the second advertisement. For instance, wireless communication device 114 of computing device 110 may reestablish, based on interpreting the second address identifier, a connection with one or more wireless communication device 174 responsive to being temporarily disconnected from computing device 110. In some instances, device 170A may ignore the second advertisement if wireless connectivity between device 170A and computing device 110 is already established.

In instances where device 170A is connected to computing device 110 (e.g., based on a first advertisement), advertisement module 124 may generate a second advertisement to include indications of an availability of a service provided by computing device 110 (e.g., availability of a data-collecting sensor of computing device 110), general announcements associated with computing device 110 (e.g., device state information, connection strength information, etc.), and/or other data that may be communicated to device 170A in an advertisement (e.g., application-specific data, location data, etc.). Advertisement module 124 may send the second advertisement to wireless communication devices 174A of device 170A using wireless communication device 114. Wireless communication device 174A may use a key (e.g., an IRK) -associated with a first address identifier (e.g., a first RPA) of the first advertisement and a second address identifier (e.g., a second RPA) of the second advertisement—to interpret the second address identifier of the second advertisement as being associated with a physical identity address (e.g., media access control address) of computing device 110. In response to determining the second advertisement originated from computing device 110, device 170A may accept the second advertisement and process any data included in the second advertisement (e.g., connect to a sensor of computing device 110, output state information of computing device 110 for display, perform an action based on application-specific data, etc.).

The techniques described herein may provide one or more technical advantages that realize one or more practical applications. For example, by integrating address rotation unit 116 to trigger address rotation for computing device 110, rather than processing unit 112 triggering address rotation, computing device 110 may enhance user privacy and/or improve power efficiency of computing device 110. Because address rotation unit 116 is a separate, distinct component from processing unit 112, address rotation unit 116 may trigger address rotation while processing unit 112 is operating in a low-power mode. In this way, address rotation unit 116 may trigger address rotation for computing device 110 according to an address rotation timer defining a probability distribution (e.g., a uniform distribution) of a random time interval with a range of time of seconds. For instance, computing device 110 may make it more difficult for external devices to monitor behavior of a user operating computing device 110 because computing device 110 randomly updates address identifiers for computing device 110 in a way that the external devices (e.g., external devices in a store where computing device 110 was temporarily located) may not identify computing device 110.

In general, by triggering address rotation according to a random time interval with a time range of seconds, address rotation unit 116 may enhance user privacy of a user operating computing device 110 (e.g., triggering the update of address identifiers for computing device 110 in an unpredictable update pattern that makes it more difficult to track computing device 110). In addition, by triggering address rotation while processing unit 112 operates in a low-power mode, address rotation unit 116 may improve power efficiency of computing device 110 by relieving processing unit 112 of the power consumption burden of constantly managing and reconfiguring address rotation timers that conventional devices may implement to cause a processing unit (e.g., processing unit 112) to trigger address rotation while operating in a low-power mode.

FIG. 2 is a conceptual diagram illustrating example computing device 210 with example address rotation unit 216 configured to trigger address rotation for example computing device 210, in accordance with one or more aspects of the present disclosure. Computing device 210, processing unit 212, wireless communication device 214, address rotation unit 216, low power mode module 222, and advertisement module 224 of FIG. 2 may be example or alternative implementations of computing device 110, processing unit 112, wireless communication device 114, address rotation unit 116, low power mode module 122, and advertisement module 124 of FIG. 1, respectively. In the example of FIG. 2, computing device 210 may include processing unit 212, communication units 254, one or more input device 258, one or more output devices 256, one or more storage devices 218, and power source 252.

Power source 252 may provide power to one or more components of computing device 210. In some examples, power source 252 may be a battery. Power source 252 may provide power to components 212, 254, 256, and 258 of computing device 210, for example. Examples of power source 252 may include, but are not necessarily limited to, batteries having zinc-carbon, lead-acid, nickel cadmium (NiCd), nickel metal hydride (NiMH), lithium ion (Li-ion), and/or lithium polymer (Lipo) chemistries. In some examples, power source 252 may have a limited capacity (e.g., 1000-3000 mAh).

One or more input devices 258 (referred to herein as “input devices 258”) of computing device 210 may receive input. Examples of input are tactile, audio, and video input. Input devices 258 may include a presence-sensitive display, a fingerprint sensor, touch-sensitive screen, mouse, keyboard, voice responsive system, video camera, microphone, or any other type of device for detecting input from a human or machine.

One or more output devices 256 (referred to herein as “output devices 256”) of computing device 210 may generate one or more outputs. Examples of outputs are tactile, audio, and video output. Output devices 256 may include a presence-sensitive display, sound card, video graphics adapter card, speaker, liquid crystal display (LCD), or any other type of device for generating output to a human or machine.

One or more storage devices 218 (referred to herein as “storage devices 218) may store information for processing during operation of computing device 210 (e.g., computing device 210 may store data accessed by address rotation module 226, advertisement module 224, and operating system 220 during execution at computing device 210). In some examples, storage devices 218 may include temporary memory, meaning that a primary purpose of storage devices 218 is not long-term storage. Storage devices 218 may be configured for short-term storage of information as volatile memory and therefore not retain stored contents if powered off. Examples of volatile memories include random access memories (RAM), dynamic random access memories (DRAM), static random access memories (SRAM), and other forms of volatile memories.

Storage devices 218 may include one or more computer-readable storage media. Storage devices 218 may be configured to store larger amounts of information than volatile memory. Storage devices 218 may further be configured for long-term storage of information as non-volatile memory space and retain information after power on/off cycles. Examples of non-volatile memories include magnetic hard discs, optical discs, flash memories, or forms of electronically programmable memories (EPROM) or electronically erasable and programmable (EEPROM) memories. Storage devices 218 may store program instructions and/or information associated with address rotation module 226, advertisement module 224, and operating system 220.

Operating system 220 (“OS 220”) may control operation of components of computing device 210. For example, OS 220 may facilitate the communication of address rotation module 226 and advertisement module 224 with address rotation unit 216, wireless communication device 214, and storage devices 218. In some examples, OS 220 may manage interactions between software applications and a user of computing device 210. OS 220 may have a kernel that facilitates interactions with underlying hardware of computing device 210 and provides a fully formed application space capable of executing a wide variety of software applications having secure partitions in which each of the software applications executes to perform various operations.

In the example of FIG. 2, OS 220 includes low power mode module 222 and operating system (OS) policies 232. Low power mode module 222 may implement operating system policies of OS policies 232 to initiate low power mode of processing unit 212. OS policies 232 may include operating policies associated with transitioning processing unit 212 to a low-power mode state. Low power mode module 222 may implement operating system policies to cause processing unit 212 to enter low-power mode based on utilization of processing unit 212 stored at processing unit data 262.

Processing unit data 262 may store utilization of processing unit 212 such as metrics associated with an idle time associated with processing unit 212, task scheduling and load average associated with processing unit 212, an interrupt frequency associated with processing unit 212, thermal metrics associated with processing unit 212, sleep/wake timers associated with processing unit 212, dynamic voltage and frequency scaling (DVFS) metrics associated with processing unit 212, input/output (I/O) activity associated with processing unit 212, performance counters associated with processing unit 212, context switch rate associated with processing unit 212, or the like. Low power mode module 222 may detect utilization of processing unit 212 by accessing data stored at processing unit data 262. Low power mode module 222 may compare utilization of processing unit 212, stored at processing unit data 262, to thresholds of an operating policy, stored at OS policies 232, to determine whether to initiate low-power mode of processing unit 212. For instance, based on low power mode module 222 determining processing unit data 262 indicates that an idle time of processing unit 212 satisfies a threshold defined in an operating system policy (e.g., an idle time of processing unit 112 greater than 30 minutes), low power mode module 222 may send a command to processing unit 212 to enter a low-power mode. In response to receiving the command to enter the low-power mode, processing unit 212 may save data stored at processing unit to storage device 218, or more specifically processing unit data 262, for example. Processing unit 212 may reduce clock signals and power associated with processing unit 212. Processing unit 212 may, based on saving processing unit data and reducing clocks signals and power, enter the low-power mode.

Address rotation unit 216 is a distinct component from processing unit 212. In some examples, as illustrated in FIG. 2, address rotation unit 216 may be integrated in wireless communication device 214 (e.g., personal area network chip). In some instances, address rotation unit 216 may be an independent SOC, MCU, or other AOC. Address rotation unit 216 may implement functionality and/or execute instructions associated with communication management. For example, address rotation unit 216 may receive and execute instructions that provide the functionality of address rotation module 226. These instructions executed by address rotation unit 216 may cause computing device 210 to store and/or modify information within storage devices 207 or communication units 254 during program execution. Address rotation unit 216 may execute instructions of address rotation module 226 to perform one or more operations. That is address rotation module 226 may be operable by address rotation unit 216 to perform various functions described herein.

Address rotation module 226, in the example of FIG. 2, may include timer module 236. Timer module 236 may include one or more timers associated with initiating or otherwise triggering address rotation. Timer module 236 may include one or more timers defining a specified time range according to a uniformly distributed random interval. For example, timer module 236 may include a distribution function for an address rotation timer that outputs random time intervals. Timer module 236 may apply the distribution function to determine a first random interval after an active address identifier for computing device 210 has been determined. In response to the random interval expiring or otherwise elapsing, timer module 236 may trigger address rotation by sending instructions to advertisement module 224 to perform address rotation. Timer module 236 may apply the distribution function to determine a second random interval that defines how long until timer module 236 triggers determination of a new active address identifier for computing device 210. Timer module 236 may maintain a timer for different functionalities associated with active address identifiers of computing device 210. For example, timer module 236 may maintain a first timer for address rotation associated with discovering new devices (e.g., address rotation for 1-many advertisements) and a second timer for address rotation associated with active connections with other devices (e.g., address rotation for 1-1 advertisements).

OS 220 may delegate address rotation module 226 to address rotation unit 216. OS 220 may delegate address rotation module 226 to address rotation unit 216 by scheduling instructions for address rotation triggering with address rotation unit 216. OS 220 may delegate instructions for address rotation module 226 to address rotation unit 216 responsive to computing device 210 booting up (e.g., a boot-delegate model). OS 220 may delegate instructions for address rotation module 226 to address rotation unit 216 based on hardware information of wireless communication device 214 stored at configuration data 228. Configuration data 228 may include data representing a hardware abstraction layer (HAL) interface that stores mappings of virtual resources associated with computing device 210 to physical resources associated with computing device 210. OS 220 may determine, based on HAL data stored at configuration data 228, that wireless communication device 214, or more specifically address rotation unit 216, can support the control logic for implementing address rotation module 226. Based on determining that address rotation unit 216 can support address rotation triggering associated with address rotation module 226, OS 220 may delegate instructions for address rotation module 226 to address rotation unit 216 to control address rotation triggering messages based on one or more address rotation timers. In some examples, computing device 210 may receive a firmware update to update wireless communication device 214 to include functionality of address rotation unit 216 as described herein. By OS 220 delegating connection management tasks, such as triggering address rotation, to address rotation unit 216, OS 220 may be isolated from the connection management tasks.

Communication units 254 of computing device 210 may communicate with one or more external devices via one or more wired and/or wireless networks by transmitting and/or receiving network signals on the one or more networks. Examples of communication units 254 may include a network interface card (e.g., Ethernet card), an optical transceiver, a radio frequency transceiver, a GNSS receiver, or any other type of device that can send and/or receive information. Other examples of communication units 254 may include short wave radios, cellular data radios (for terrestrial and/or satellite cellular networks), wireless network radios, as well as USB controllers.

Communication units 254 may include wireless communication device 214. Wireless communication device 214 may implement functionality and/or execute instructions associated with communication management. For example, wireless communication device 214 may receive and execute instructions that provide the functionality of advertisement module 224. These instructions executed by wireless communication device 214 may cause computing device 210 to store and/or modify information within storage devices 207 or communication units 254 during program execution. Wireless communication device 214 may execute instructions of advertisement module 224 to perform one or more operations. That is advertisement module 224 may be operable by wireless communication device 214 to perform various functions described herein.

Advertisement module 224, in the example of FIG. 2, may include address generator 238, wireless communication protocol 242, and advertisement generator 244. Address generator 238 of advertisement module 224 may generate active address identifiers for computing device 210 according to wireless communication protocol 242. Wireless communication protocol 242 may include protocol specifications, configuration data, firmware, software, control information, calibration data, dynamic parameters, or other information advertisement module 224 may apply to generate address identifiers and advertisements for computing device 210. For example, wireless communication protocol 242 may include Standards and Protocol Definitions, channel information, power settings, encryption keys, command and control instructions, status information, buffers, queues, or other data for initiating and maintaining wireless connections with external devices. Wireless communication protocol 242 may store data specifying how to determine active address identifiers for various types of advertisements. For example, wireless communication protocol 242 may specify that a first type of active address identifier is to be generated for broadcasting connection requests and a second type of active address identifier is to be generated for active connections with external devices.

Address generator 238 may generate active address identifiers responsive to timer module 236 determining the timer associated with initiating address rotation has expired. Address generator 238 may, based on timers implemented by timer module 236, periodically generate a new active address identifier using a pseudo-random number generator, for example. Address generator 238 may generate active address identifiers as a resolvable private address (RPA) or a non-resolvable private address according to a wireless communication protocol (e.g., BLE, WI-FI, etc.). Address generator 238 may send generated active address identifiers to advertisement generator 244. Advertisement generator 244 may maintain or otherwise set a most recent address identifier as an active address identifier that identifies computing device 210.

Advertisement generator 244 of advertisement module 224 may generate advertisements based on active address identifiers determined by address generator 238. Advertisement generator 244 may include a most recent address identifier received from address generator 238 in advertising packets. In some examples, advertisement generator 244 may include, responsive to receiving explicit user consent, a key (e.g., a BLUETOOTH IRK) associated with active address identifiers generated by address generator 238 in advertisements (e.g., personal area network advertisements, local area network advertisements, etc.) sent to external devices. For example, advertisement generator 244 may send an IRK associated with an active RPA update to an external device responsive to computing device 210 receiving an indication from a user operating computing device 210 to connect to the external device. In some instances, if computing device 210 is connected to the external device and address rotation unit 216 triggers an RPA update using a new IRK, advertisement generator 244 may broadcast the new IRK associated with the RPA update. In general, if an external device has a key associated with an active address identifier, the external device may resolve the active address identifier and identify computing device 210 based on an identity address (e.g., MAC address) associated with the active address identifier. In some instances, advertisement generator 244 may notify devices with active connections with computing device 210 that an active address identifier for computing device 210 has changed in order to allow such devices to continue to connect to computing device 210. Advertisement generator 244 may broadcast advertisements to external devices using wireless communication device 214.

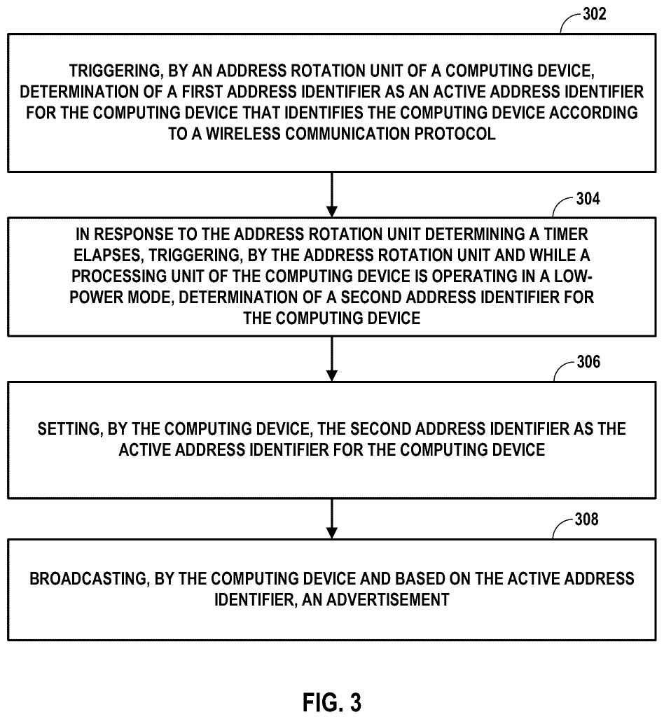

FIG. 3 is a flowchart of an example process for triggering address rotation while a processing unit is operating in a low-power mode, in accordance with one or more aspects of the present disclosure. FIG. 3 may be discussed with respect to FIG. 1 for example purposes only.

Address rotation unit 116 of computing device 110 may trigger determination of a first address identifier as an active address identifier for computing device 110 that identifies computing device 110 according to a wireless communication protocol (302). Address rotation unit 116 may include at least one of a system on a chip, a microcontroller, or an always on chip. In some instances, address rotation unit 116 may be a component of wireless communication device 114. Address rotation unit 116 may be a distinct component from processing unit 112 of computing device 110.

Address rotation unit 116 may, in response to determining a timer elapses, trigger, while processing unit 112 is operating in a low-power mode, determination of a second address identifier for the computing device (304). For example, responsive to address rotation unit 116 determining the timer (e.g., a timer indicating a uniformly distributed time interval in the order of seconds) elapses, address rotation unit 116 may send, to wireless communication device 114, instructions that cause wireless communication device 114 to perform address rotation for computing device 110. Wireless communication device 114 may perform address rotation for computing device 110 by, for example, generating the second address identifier as a BLUETOOTH RPA using a BLUETOOTH IRK.

Computing device 110 may set the second address identifier as the active address identifier for computing device 110 (306). For example, wireless communication device 114 of computing device 110 may set the second address identifier as the active address identifier that is to be used in advertisements output by computing device 110. Computing device 110, or more specifically wireless communication device 114, may broadcast, based on the active address identifier, an advertisement (308). For instance, wireless communication device 114 may generate the advertisement to include the active address identifier in a portion of the advertisement associated with resolvable private addresses. Wireless communication device 114 may broadcast the advertisement to computing devices 170 that in a communication range associated with the wireless communication protocol. Computing device 110 may connect to one or more of devices 170 based on the advertisement.

Example 1: A method includes triggering, by an address rotation unit of a computing device, determination of a first address identifier for the computing device, wherein the first address identifier is an active address identifier for the computing device that identifies the computing device according to a wireless communication protocol, and wherein the address rotation unit is a distinct component from a processing unit of the computing device; in response to the address rotation unit determining a timer elapses, triggering, by the address rotation unit and while the processing unit is operating in a low-power mode, determination of a second address identifier for the computing device; setting, by the computing device, the second address identifier as the active address identifier for the computing device; and broadcasting, by the computing device and based on the active address identifier, an advertisement, wherein the advertisement conforms to the wireless communication protocol.

Example 2: The method of example 1, wherein the processing unit comprises one or more central processing units of the computing device.

Example 3: The method of any of examples 1 and 2, wherein the address rotation unit comprises at least one of: a system on a chip, a microcontroller unit, or an always on chip.

Example 4: The method of any of examples 1 through 3, wherein the wireless communication protocol is a personal area network protocol, and wherein triggering determination of the second address identifier for the computing device comprises: determining, by the address rotation unit, the timer elapsed; and sending, from the address rotation unit to a wireless communication device of the computing device, instructions that cause the wireless communication device to: generate the second address identifier using a BLUETOOTH identity resolving key, wherein the second address identifier is a resolvable private address associated with a media access control address identifying the computing device, and set the second address identifier as the active address identifier for the computing device.

Example 5: The method of any of examples 1 through 4, wherein the advertisement corresponds to a personal area network advertisement.

Example 6: The method of any of examples 1 through 5, wherein broadcasting the advertisement comprises: generating, using a wireless communication device of the computing device, the advertisement to include the active address identifier; and broadcasting, by the wireless communication device, the advertisement to a set of computing devices in a communication range associated with the wireless communication protocol.

Example 7: The method of example 6, wherein the address rotation unit is a component of the wireless communication device.

Example 8: The method of any of examples 6 and 7, wherein the computing device is a first computing device, and wherein the method further comprises: connecting, using the wireless communication device and based on the advertisement, the first computing device to a second computing device included in the set of computing devices.

Example 9: The method of any of examples 1 through 8, further includes delegating, by an operating system of the computing device to the address rotation unit, the timer, wherein the timer indicates a time range in seconds according to a uniformly distributed random interval; and managing, by the address rotation unit, the timer to determine when the timer has elapsed.

Example 10: The method of any of examples 1 through 9, further includes sending, by an operating system to the processing unit, a command to enter the low-power mode; saving, by the processing unit to a storage device, data stored at the processing unit; reducing, by the processing unit, clock signals and power associated with the processing unit; and entering, by the processing unit and based on the command, the low-power mode.

Example 11: A computing device includes a processing unit; a wireless communication device; an address rotation unit; and a storage device that stores instructions executable by the address rotation unit to: trigger determination of a first address identifier for the computing device, wherein the first address identifier is an active address identifier for the computing device that identifies the computing device according to a wireless communication protocol, and wherein the address rotation unit is a distinct component from the processing unit, determine a timer elapses, and trigger, based on the timer and while the processing unit is operating in low-power mode, determination of a second address identifier for the computing device, and wherein the storage device stores instructions executable by the wireless communication device to: set the second address identifier as the active address identifier for the computing device, and broadcast, based on the active address identifier, an advertisement, wherein the advertisement conforms to the wireless communication protocol.

Example 12: The computing device of example 11, wherein the address rotation unit is a component of the wireless communication device.

Example 13: The computing device of any of examples 11 and 12, wherein the address rotation unit comprises at least one of: a system on a chip, a microcontroller unit, or an always on chip.

Example 14: The computing device of any of examples 11 through 13, wherein the processing unit comprises one or more central processing units of the computing device.

Example 15: The computing device of any of examples 11 through 14, wherein the wireless communication protocol is a personal area network protocol, and wherein to trigger determination of the second address identifier for the computing device, the instructions executable by the address rotation unit cause the address rotation unit to: send, to the wireless communication device, instructions that cause the wireless communication device to: generate the second address identifier using a BLUETOOTH identity resolving key, wherein the second address identifier is a resolvable private address associated with a media access control address identifying the computing device, and set the second address identifier as the active address identifier for the computing device.

Example 16: The computing device of any of examples 11 through 15, wherein the advertisement corresponds to a personal area network advertisement.

Example 17: The computing device of any of examples 11 through 16, wherein to broadcast the advertisement, the storage device stores instructions executable by the wireless communication device to: generate the advertisement to include the active address identifier; and broadcast the advertisement to a set of computing devices in a communication range associated with the wireless communication protocol.

Example 18: The computing device of example 17, wherein the storage device further stores instructions executable by the wireless communication device to: connect, based on the advertisement, the computing device to one or more computing devices included in the set of computing devices.

Example 19: The computing device of any of examples 11 through 18, wherein the storage device stores instructions executable by the processing unit to: receive a command to enter low-power mode; save data stored at the processing unit; reduce clock signals and power associated with the processing unit; and enter, based on the command, low-power mode.

Example 20: The computing device of any of examples 11 through 19, wherein the storage device stores instructions executable by the processing unit to: delegate, by an operating system of the computing device, the timer to the address rotation unit, wherein the timer indicates a time range in seconds according to a uniformly distributed random interval.

Example 21: The computing device of any of examples 11 through 20, wherein to determine the timer elapses, the storage device stores instructions executable by the address rotation unit to: manage the timer to determine when the timer has elapsed, wherein the timer indicates a time range in seconds according to a uniformly distributed random interval.

Example 22: Non-transitory computer-readable storage media storing instructions that, when executed, cause a computing device to: trigger, by an address rotation unit of the computing device, determination of a first address identifier for the computing device, wherein the first address identifier is an active address identifier for the computing device that identifies the computing device according to a wireless communication protocol, and wherein the address rotation unit is a distinct component from a processing unit of the computing device; in response to the address rotation unit determining a timer elapses, trigger, by the address rotation unit and while the processing unit is operating in low-power mode, determination of a second address identifier for the computing device; set the second address identifier as the active address identifier for the computing device; and broadcast, based on the active address identifier, an advertisement, wherein the advertisement conforms to the wireless communication protocol.

Example 23: The non-transitory computer-readable storage media of example 22, wherein the processing unit comprises one or more central processing units of the computing device.

Example 24: The non-transitory computer-readable storage media of any of examples 22 and 23, wherein the address rotation unit comprises at least one of: a system on a chip, a microcontroller unit, or an always on chip.

Example 25: The non-transitory computer-readable storage media of any of examples 22 through 24, wherein the wireless communication protocol is a personal area network protocol, and wherein to trigger determination of the second address identifier, the instructions cause the computing device to: determine, by the address rotation unit, the timer elapsed; and send, from the address rotation unit to a wireless communication device of the computing device, instructions that cause the wireless communication device to: generate the second address identifier using a BLUETOOTH identity resolving key, wherein the second address identifier is a resolvable private address associated with a media access control address identifying the computing device, and set the second address identifier as the active address identifier for the computing device; and broadcast, based on the active address identifier, an advertisement, wherein the advertisement conforms to the wireless communication protocol.

Example 26: The non-transitory computer-readable storage media of example 25, wherein the address rotation unit is a component of the wireless communication device.

Example 27: The non-transitory computer-readable storage media of any of examples 22 through 26, wherein the advertisement corresponds to a personal area network advertisement.

Example 28: The non-transitory computer-readable storage media of any of examples 22 through 27, wherein to broadcast the advertisement, the instructions cause the computing device to: generate, using a wireless communication device of the computing device, the advertisement to include the active address identifier; and generate, by the wireless communication device, the advertisement to a set of computing devices in a communication range associated with the wireless communication protocol.

Example 29: The non-transitory computer-readable storage media of example 28, wherein the computing device is a first computing device, and wherein the instructions further cause the first computing device to: connect, using the wireless communication device and based on the advertisement, the first computing device to a second computing device included in the set of computing devices.

Example 30: The non-transitory computer-readable storage media of any of examples 22 through 29, wherein the instructions further cause the computing device to: send, by an operating system to the processing unit, a command to enter the low-power mode; save, by the processing unit to a storage device, data stored at the processing unit; reduce, by the processing unit, clock signals and power associated with the processing unit; and enter, by the processing unit and based on the command, the low-power mode.

Example 31: The non-transitory computer-readable storage media of any of examples 16 through 30, wherein the instructions further cause the computing device to: delegate, by an operating system of the computing device to the address rotation unit, the timer, wherein the timer indicates a time range in seconds according to a uniformly distributed random interval; and manage, by the address rotation unit, the timer to determine when the timer has elapsed.

Example 32: A computing system comprising means for performing any combination of examples 1-31.

Example 33: A computer program product comprising one or more instructions that, when executed by a computing device, cause the computing device to perform any combination of examples 1-31.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise random-access memory (RAM), read-only memory (ROM), EEPROM, compact disc read-only memory (CD-ROM) or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
triggering, by an address rotation unit of a computing device, determination of a first address identifier for the computing device, wherein the first address identifier is an active address identifier for the computing device that identifies the computing device according to a wireless communication protocol, and wherein the address rotation unit is a distinct component from a processing unit of the computing device;
in response to the address rotation unit determining a timer elapses, triggering, by the address rotation unit and while the processing unit is operating in a low-power mode, determination of a second address identifier for the computing device;
setting, by the computing device, the second address identifier as the active address identifier for the computing device; and
broadcasting, by the computing device and based on the active address identifier, an advertisement, wherein the advertisement conforms to the wireless communication protocol.

2. The method of claim 1, wherein the processing unit comprises one or more central processing units of the computing device.

3. The method of claim 1, wherein the address rotation unit comprises at least one of: a system on a chip, a microcontroller unit, or an always on chip.

4. The method of claim 1, wherein the wireless communication protocol is a personal area network protocol, and wherein triggering determination of the second address identifier for the computing device comprises:
determining, by the address rotation unit, the timer elapsed; and
sending, from the address rotation unit to a wireless communication device of the computing device, instructions that cause the wireless communication device to:
generate the second address identifier using a BLUETOOTH identity resolving key, wherein the second address identifier is a resolvable private address associated with a media access control address identifying the computing device, and
set the second address identifier as the active address identifier for the computing device.

5. The method of claim 1, wherein the advertisement corresponds to a personal area network advertisement.

6. The method of claim 1, wherein broadcasting the advertisement comprises:
generating, using a wireless communication device of the computing device, the advertisement to include the active address identifier; and
broadcasting, by the wireless communication device, the advertisement to a set of computing devices in a communication range associated with the wireless communication protocol.

7. The method of claim 6, wherein the address rotation unit is a component of the wireless communication device.

8. The method of claim 6, wherein the computing device is a first computing device, and wherein the method further comprises: connecting, using the wireless communication device and based on the advertisement, the first computing device to a second computing device included in the set of computing devices.

9. The method of claim 1, further comprising:
delegating, by an operating system of the computing device to the address rotation unit, the timer, wherein the timer indicates a time range in seconds according to a uniformly distributed random interval; and
managing, by the address rotation unit, the timer to determine when the timer has elapsed.

10. The method of claim 1, further comprising:
sending, by an operating system to the processing unit, a command to enter the low-power mode;
saving, by the processing unit to a storage device, data stored at the processing unit;
reducing, by the processing unit, clock signals and power associated with the processing unit; and
entering, by the processing unit and based on the command, the low-power mode.

11. A computing device comprising:
a processing unit;
a wireless communication device;
an address rotation unit; and
a storage device that stores instructions executable by the address rotation unit to:
trigger determination of a first address identifier for the computing device, wherein the first address identifier is an active address identifier for the computing device that identifies the computing device according to a wireless communication protocol, and wherein the address rotation unit is a distinct component from the processing unit,
determine a timer elapses, and
trigger, based on the timer and while the processing unit is operating in low-power mode, determination of a second address identifier for the computing device,
wherein the storage device stores instructions executable by the wireless communication device to:
set the second address identifier as the active address identifier for the computing device, and
broadcast, based on the active address identifier, an advertisement, wherein the advertisement conforms to the wireless communication protocol.

12. The computing device of claim 11, wherein the address rotation unit is a component of the wireless communication device.

13. The computing device of claim 11, wherein the processing unit comprises one or more central processing units of the computing device.

14. The computing device of claim 11, wherein the wireless communication protocol is a personal area network protocol, and wherein to trigger determination of the second address identifier for the computing device, the instructions executable by the address rotation unit cause the address rotation unit to:
send, to the wireless communication device, instructions that cause the wireless communication device to:
generate the second address identifier using a BLUETOOTH identity resolving key, wherein the second address identifier is a resolvable private address associated with a media access control address identifying the computing device, and
set the second address identifier as the active address identifier for the computing device.

15. The computing device of claim 11, wherein the storage device stores instructions executable by the processing unit to: delegate, by an operating system of the computing device, the timer to the address rotation unit, wherein the timer indicates a time range in seconds according to a uniformly distributed random interval.

16. Non-transitory computer-readable storage media storing instructions that, when executed, cause a computing device to:
trigger, by an address rotation unit of the computing device, determination of a first address identifier for the computing device, wherein the first address identifier is an active address identifier for the computing device that identifies the computing device according to a wireless communication protocol, and wherein the address rotation unit is a distinct component from a processing unit of the computing device;
in response to the address rotation unit determining a timer elapses, trigger, by the address rotation unit and while the processing unit is operating in low-power mode, determination of a second address identifier for the computing device;
set the second address identifier as the active address identifier for the computing device; and
broadcast, based on the active address identifier, an advertisement, wherein the advertisement conforms to the wireless communication protocol.

17. The non-transitory computer-readable storage media of claim 16, wherein the processing unit comprises one or more central processing units of the computing device.

18. The non-transitory computer-readable storage media of claim 16, wherein the wireless communication protocol is a personal area network protocol, and wherein to trigger determination of the second address identifier, the instructions cause the computing device to:
determine, by the address rotation unit, the timer elapsed; and
send, from the address rotation unit to a wireless communication device of the computing device, instructions that cause the wireless communication device to:
generate the second address identifier using a BLUETOOTH identity resolving key, wherein the second address identifier is a resolvable private address associated with a media access control address identifying the computing device, and
set the second address identifier as the active address identifier for the computing device.

19. The non-transitory computer-readable storage media of claim 18, wherein the address rotation unit is a component of the wireless communication device.

20. The non-transitory computer-readable storage media of claim 16, wherein the instructions further cause the computing device to:
delegate, by an operating system of the computing device to the address rotation unit, the timer, wherein the timer indicates a time range in seconds according to a uniformly distributed random interval; and
manage, by the address rotation unit, the timer to determine when the timer has elapsed.
